(19) United States
(12) Patent Application Publication
(10) Pub. No.: US 2024/0177405 A1
(43) Pub. Date: May 30, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: YOSHIHIKO MINATO, Kanagawa (JP)

(21) Appl. No.: 18/518,072

(22) Filed: Nov. 22, 2023

(30) Foreign Application Priority Data
Nov. 29, 2022 (JP) 2022-190838

(51) Int. Cl. G06T 15/20; G06F 3/0484

(52) U.S. Cl. CPC G06T 15/205; G06F 3/0484; G06T 2200/24

(57) ABSTRACT

An image processing apparatus includes one or more memories storing instructions, and one or more processors executing the instructions to generate a virtual viewpoint image based on a plurality of images captured by a plurality of image capturing apparatuses and based on information indicating a position and an orientation of a virtual camera, generate, based on input of a generation instruction, permission information indicating that an operation of the virtual camera corresponding to the virtual viewpoint image is permitted, and output the virtual viewpoint image and the permission information in association with each other.

### BACKGROUND OF THE DISCLOSURE

### Field of the Disclosure

The present disclosure relates to a technique for operating a virtual viewpoint corresponding to a virtual viewpoint image.

### Description of the Related Art

A technique for generating a virtual viewpoint image viewed from a designated virtual viewpoint by using a plurality of images captured from different directions by a plurality of cameras has attracted attention. Japanese Patent Application Laid-Open No. 2015-045920 discusses a method in which images of an object are captured by a plurality of cameras installed at different positions, and a virtual viewpoint image is generated using a three-dimensional shape model of the object estimated based on the captured images.

Meanwhile, a blockchain technique for assigning a non-fungible token (NFT) to a digital item in a virtual space or a computer game, or digital content such as digital artwork to certify ownership thereof has attracted attention. United States Patent Application Publication 2017316608 discusses a method for assigning ownership to digital items.

### SUMMARY OF THE DISCLOSURE

According to an aspect of the present disclosure, an image processing apparatus includes one or more memories storing instructions, and one or more processors executing the instructions to generate a virtual viewpoint image based on a plurality of images captured by a plurality of image capturing apparatuses and based on information indicating a position and an orientation of a virtual camera, generate, based on input of a generation instruction, permission information indicating that an operation of the virtual camera corresponding to the virtual viewpoint image is permitted, and output the virtual viewpoint image and the permission information in association with each other.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus.

FIG. 2 is a block diagram illustrating a virtual viewpoint image generation system according to one or more aspects of the present disclosure.

FIG. 3 is a block diagram illustrating a virtual viewpoint image reproduction system according to one or more aspects of the present disclosure.

FIG. 4 is a schematic diagram illustrating examples of a user interface (UI) for editing a virtual camera path.

FIG. 5 is a diagram illustrating an example of non-fungible token (NFT) content selling.

FIG. 6 is a flowchart illustrating virtual viewpoint image generation according to one or more aspects of the present disclosure.

FIG. 7 is a flowchart illustrating virtual viewpoint image regeneration according to the first exemplary embodiment.

FIG. 8 is a flowchart illustrating virtual viewpoint image regeneration according to one or more aspects of the present disclosure.

FIG. 9 is a block diagram illustrating a configuration of a virtual viewpoint image generation system according to one or more aspects of the present disclosure.

FIG. 10 is a flowchart illustrating NFT assignment according to one or more aspects of the present disclosure.

FIG. 11 is a diagram illustrating an example of keyframe information to which an NFT is to be assigned according to one or more aspects of the present disclosure.

FIG. 12 is a block diagram illustrating an example of a hardware configuration according to one or more aspects of the present disclosure.

FIG. 13 is a sequence diagram illustrating a processing procedure for virtual viewpoint image generation according to one or more aspects of the present disclosure.

### DESCRIPTION OF THE EMBODIMENTS

Exemplary embodiments of the present disclosure will be described in detail below with reference to the drawings. The present disclosure is not limited to the following exemplary embodiments. In the drawings, the same or similar components are denoted by the same reference numerals, and repetitive description thereof will be omitted.

### <Manual Operation>

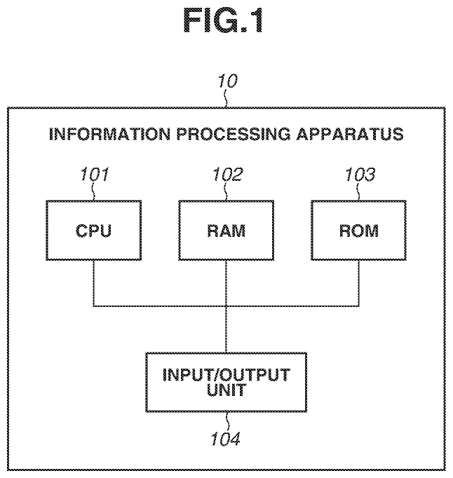

FIG. 1 is a block diagram illustrating a hardware configuration of an information processing apparatus 10 according to a first exemplary embodiment of the present disclosure.

A central processing unit (CPU) 101 controls the entire operation of the information processing apparatus 10 by using computer programs and data stored in a random-access memory (RAM) 102 or a read only memory (ROM) 103. The information processing apparatus 10 may include one or a plurality of pieces of dedicated hardware and one or a plurality of graphics processing units (GPUs) different from the CPU 101, and the GPUs and the dedicated hardware may perform at least a part of processing by the CPU 101. Examples of the dedicated hardware include an application-specific integrated circuit (ASIC) and a digital signal processor (DSP).

The RAM 102 temporarily stores computer programs and data read out from the ROM 103, data supplied from an external apparatus via an input/output unit 104, and the like.

The ROM 103 stores computer programs and data not to be changed.

The input/output unit 104 inputs and outputs data to and from a controller for editing a virtual camera path, a display for displaying a graphical user interface (GUI), and the like.

### <Configuration>

In the present exemplar embodiment, two configurations are used. One is a configuration used in a case where a virtual viewpoint image content creator generates a virtual viewpoint image. The other is a configuration used in a case where the generated virtual viewpoint image is operated by a purchaser.

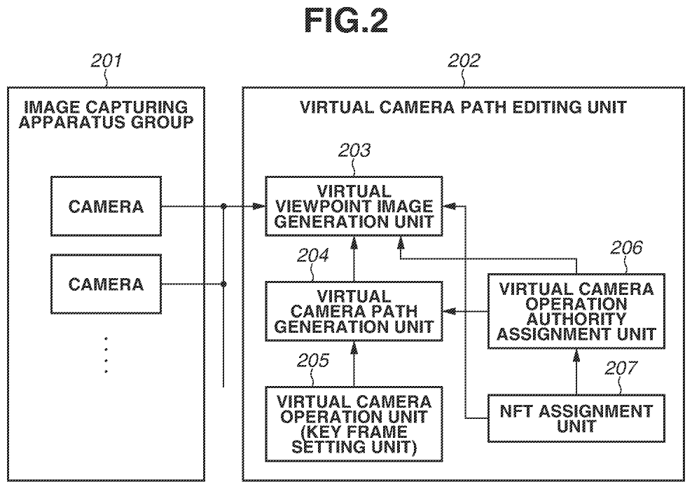

FIG. 2 illustrates a virtual viewpoint image generation system that has the configuration used in the case where a virtual viewpoint image content creator generates a virtual viewpoint image. This configuration is based on an assumption that the virtual viewpoint image content creator generates a default virtual camera path by using captured image data.

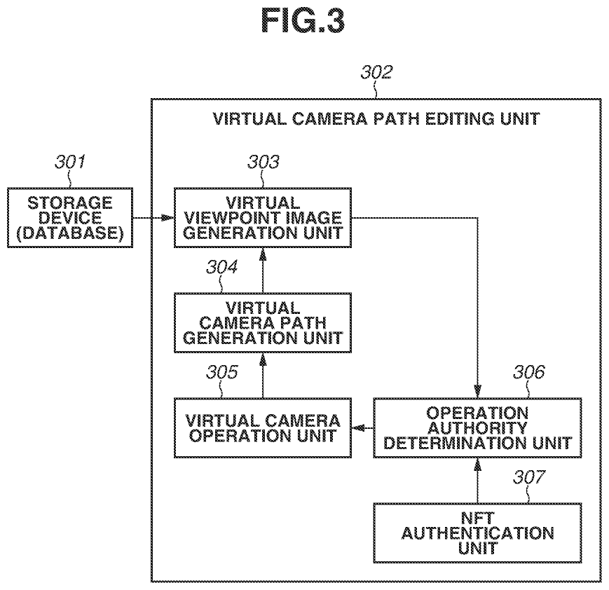

FIG. 3 illustrates the configuration used in the case where the generated virtual viewpoint image is operated by the purchaser. This configuration is based on an assumption that the purchaser of the virtual viewpoint image operates the virtual viewpoint image within an operation range corresponding to a purchase price.

In the present exemplary embodiment, a method will be described in which a non-fungible token (NFT) is assigned to the authority to operate a virtual camera corresponding to the virtual viewpoint image, and the purchaser of the virtual viewpoint image controls the virtual camera based on this owner information. The NFT is one of tokens to be issued and distributed on a blockchain. Utilizing the NFT makes it possible to provide a unique value for digital content. Examples of standards for the NFT include token standards called Ethereum Request for Comments (ERC)-721 and ERC-1155.

A virtual viewpoint image according to the present exemplary embodiment is also called a free viewpoint image. However, the virtual viewpoint image is not limited to an image corresponding to a viewpoint freely (optionally) designated by a user. For example, an image corresponding to a viewpoint selected by the user from among a plurality of candidates is also included in the virtual viewpoint image. While in the present exemplary embodiment, a case where a virtual viewpoint is designated by a user operation is mainly described, the virtual viewpoint may be automatically designated based on an image analysis result. While in the present exemplary embodiment, a case where the virtual viewpoint image is a moving image is mainly described, the virtual viewpoint image may be a still image.

Viewpoint information for use in generating the virtual viewpoint image is information indicating a position and an orientation (a line-of-sight direction) of the virtual viewpoint. More specifically, the viewpoint information is a parameter set including a parameter indicating a three-dimensional position of the virtual viewpoint and a parameter indicating an orientation of the virtual viewpoint in pan, tilt, and roll directions. The viewpoint information is not limited thereto. For example, the parameter set as the viewpoint information may include a parameter indicating a size of a visual field (an angle of view) of the virtual viewpoint. The viewpoint information may also include a plurality of parameter sets. For example, the viewpoint information may include a plurality of parameter sets respectively corresponding to a plurality of frames included in the moving image as the virtual viewpoint image, and indicate the position and orientation of the virtual viewpoint at each of a plurality of continuous time points.

The virtual viewpoint image is generated, for example, as follows. First, a plurality of images (a plurality of viewpoint images) is captured from different directions by a plurality of image capturing apparatuses. Next, from the plurality of viewpoint images, a foreground image is obtained by extracting a foreground area corresponding to a predetermined object such as a person or a ball, and a background image is obtained by extracting a background area other than the foreground area. Further, a foreground model representing a three-dimensional shape of the predetermined object and texture data for coloring the foreground model are generated based on the foreground image. Texture data for coloring a background model representing a three-dimensional shape of the background such as a sports ground is also generated based on the background image. Thereafter, the corresponding texture data is mapped to each of the foreground model and the background model, and rendering is performed based on the virtual viewpoint indicated by the viewpoint information. As a result, a virtual viewpoint image is generated. However, the method for generating the virtual viewpoint image is not limited thereto, and various methods can be used, such as a method of generating the virtual viewpoint image using projective transformation of the captured images without using the three-dimensional models.

The virtual camera is different from the plurality of image capturing apparatuses actually installed around an image capturing area and is a concept for conveniently describing the virtual viewpoint relating to the generation of the virtual viewpoint image. In other words, the virtual viewpoint image can be regarded as an image captured from the virtual viewpoint set in a virtual space associated with the image capturing area. The position and orientation of the virtual viewpoint in such virtual image capturing are represented as the position and orientation of the virtual camera. In other words, the virtual viewpoint image is an image simulating, in a case where a camera is assumed to be present at the position of the virtual viewpoint set in the virtual space, an image captured by the camera. In the present exemplary embodiment, a temporal change in the virtual viewpoint is referred to as a virtual camera path. However, it is not essential to use the concept of the virtual camera in order to implement the configurations according to the present exemplary embodiment. In other words, it is sufficient to set at least information indicating a specific position and orientation in the space and generate a virtual viewpoint image based on the set information.

### <Configuration for Virtual Viewpoint Image Generation>

FIG. 2 illustrates an example of a functional configuration relating to virtual camera path generation in the information processing apparatus 10 (see FIG. 1). Referring to FIG. 2, a virtual viewpoint image content creator uses a virtual camera path editing unit 202 to generate a virtual camera path by using captured image data acquired by an image capturing apparatus group 201 for virtual viewpoint images, thereby generating a virtual viewpoint image. A virtual camera operation authority assignment unit 206 and an NFT assignment unit 207 are provided to assign virtual camera operation authority and an NFT to the generated virtual viewpoint image, respectively.

The information processing apparatus 10 includes the image capturing apparatus group 201, the virtual camera path editing unit 202, a virtual viewpoint image generation unit 203, a virtual camera path generation unit 204, a virtual camera operation unit 205, the virtual camera operation authority assignment unit 206, and the NFT assignment unit 207. The information processing apparatus 10 is assumed to be a node of a blockchain.

The image capturing apparatus group 201 includes a plurality of cameras installed to surround an athletic field or the like, and the plurality of cameras synchronously captures images and outputs the captured images to the virtual viewpoint image generation unit 203.

The virtual camera path editing unit 202 edits the virtual camera path by using the captured images and generates a virtual viewpoint image by using the virtual camera path.

The virtual camera path will now be described. The virtual camera path defines movement of the virtual camera in a moving image created by sequentially reproducing a plurality of virtual viewpoint images or a plurality of computer graphics (CG) images. The virtual camera path is managed using frames and a timeline. The frames hold information for use in generating the images of the moving image. More specifically, each frame holds information about a time (a time code) of a scene, and information about the position and orientation of the camera. Regarding the time of the scene, for example, the start time of a game, which is an image capturing target, is expressed as a time code of 00:00:00:00 (“:00” corresponds to the frame).

The position of the camera is represented by, for example, three coordinates of X, Y, and Z in a state where an origin is set in an image capturing space.

The orientation of the camera is represented by, for example, three angles, a pan angle, a tilt angle, and a roll angle.

The timeline displays the time points of the frames on one time axis. The number of frames included in the timeline is determined based on the number of images reproduced per one second (i.e., a frame rate). For example, in a case where the frame rate is 60 frames/sec, 60 frames per second are included in the timeline. Among the above-described frames, frames used as references are particularly referred to as key frames, and the time point of the key frame at the start point and the time point of the keyframe at the end point are displayed on the timeline.

The virtual viewpoint image content creator determines the position and orientation of the virtual camera at a desired time code and registers the frame as a reference frame, i.e., a key frame. The virtual viewpoint image content creator repeats this operation to register at least two or more key frames, thereby generating the virtual camera path. In editing the virtual camera path using the kay frames, the frames are classified into two types, namely, the key frames and intermediate frames. The key frames are frames each having information explicitly designated by the user editing the virtual camera path. The intermediate frames are between the key frames, and the virtual camera path editing unit 202 (described below) determines information of the intermediate frames by performing interpolation between the key frames.

The virtual camera path editing unit 202 controls the virtual camera to determine a series of parameters (hereinafter also referred to as “virtual camera parameters”) of the virtual camera in the virtual camera path. The virtual camera parameters may include a parameter for designating at least one of the position, the orientation, the zoom value, and the time point. The position of the virtual camera designated based on the virtual camera parameters may be represented by three-dimensional coordinates. The position designated based on the virtual camera parameters may also be represented by coordinates of an orthogonal coordinate system of three axes of an X axis, a Y axis, and a Z axis. In this case, the position designated based on the virtual camera parameters may be coordinates and may include parameters of the three axes of the X axis, the Y axis, and the Z axis. The origin may be any position in the three-dimensional space. The orientation of the virtual camera designated based on the virtual camera parameters may be represented by angles of three axes of pan, tilt, and roll. In this case, the orientation of the virtual camera designated based on the virtual camera parameters may be represented by parameters of the three axes of pan, tilt, and roll. The zoom value of the virtual camera designated based on the virtual camera parameters is represented by, for example, a single axis of a focal length, and each of the zoom value and the time point is a parameter of a single axis. Accordingly, the virtual camera parameters of the virtual camera include parameters of at least eight axes.

In the present exemplary embodiment, the coordinates of the X axis, the Y axis, and the Z axis are used as the virtual camera parameters indicating the position of the virtual camera, and the pan and tilt values (angles) are used as the virtual camera parameters indicating the orientation of the virtual camera.

The virtual viewpoint image generation unit 203 generates a three-dimensional model based on the images captured by the image capturing apparatus group 201. The virtual viewpoint image generation unit 203 then generates a virtual viewpoint image by performing texture mapping with the virtual viewpoint (the position, orientation, and angle of view of the virtual camera) in the virtual camera path generated by the virtual camera path generation unit 204.

The virtual camera path generation unit 204 generates the virtual camera path indicating a trajectory of the virtual camera operated by the virtual viewpoint image content creator, or the virtual camera path obtained by interpolating the frames between the key frames set by the user. The virtual camera path generation unit 204 generates the virtual camera path by using the virtual camera parameters output from the virtual camera operation unit 205 (described below) or by interpolating the frames between at least two set key frames. The virtual camera path is represented by temporally continuous virtual camera parameters. The virtual camera path generation unit 204 performs association with the time code in order to identify the parameters of each of the frames in generating the virtual camera path.

The virtual camera operation unit 205 controls the operation of the virtual camera by the virtual viewpoint image content creator, and outputs the result of the control as the virtual camera parameters to the virtual camera path generation unit 204. The virtual camera parameters include at least parameters indicating the position and orientation of the virtual camera. However, the virtual camera parameters are not limited thereto, and may include, for example, a parameter indicating the angle of view of the virtual camera. Further, in a case where an image clip is generated using a key frame method, the key frames are set based on the virtual camera parameters and key frame setting information (indicating whether to set key frames and whether to store key frames), and are output to the virtual camera path generation unit 204.

The virtual camera operation authority assignment unit 206 assigns metadata indicating the operation authority for the virtual camera to the virtual viewpoint image generated by the virtual viewpoint image generation unit 203. More specifically, the virtual camera operation authority assignment unit 206 outputs a generation instruction for generating the operation authority for the virtual camera to a generation unit (not illustrated) for generating the metadata indicating the operation authority for the virtual camera. Thereafter, the virtual camera operation authority assignment unit 206 assigns the generated metadata indicating the operation authority for the virtual camera to the virtual viewpoint image.

The operation authority for the virtual camera is the user's authority to operate the virtual camera and is permission information indicating that the user is permitted to operate the virtual camera. The metadata indicating the operation authority for the virtual camera is assumed to be information indicating the presence of the operation authority for the virtual camera or information indicating the absence of the operation authority for the virtual camera. However, the present exemplary embodiment is not limited thereto. Information indicating the operation authority for the virtual camera may be generated and stored in advance and may be assigned based on a user operation.

The NFT assignment unit 207 assigns an NFT to the virtual viewpoint image generated by the virtual viewpoint image generation unit 203 and the virtual camera operation authority set for the virtual camera path generated by the virtual camera path generation unit 204.

### <Configuration for Operation by Virtual Viewpoint Image Purchaser>

FIG. 3 illustrates a configuration in which captured image data acquired by the image capturing apparatus group 201 in FIG. 2 is read out from a storage device 301 and the virtual viewpoint image purchaser edits the virtual camera path by using a virtual camera path editing unit 302. Thus, an operation authority determination unit 306 and an NFT authentication unit 307 for interpreting the operation authority and the NFT assigned to the virtual viewpoint image when generated are provided.

The information processing apparatus 10 includes the storage device 301, the virtual camera path editing unit 302, a virtual viewpoint image generation unit 303, a virtual camera path generation unit 304, a virtual camera operation unit 305, the operation authority determination unit 306, and the NFT authentication unit 307.

The storage device 301 stores data obtained by processing, for virtual viewpoint image generation, the captured image data acquired by the image capturing apparatus group 201. A virtual viewpoint image can be generated from the stored data again by using the virtual camera path generated by the virtual camera path generation unit 304.

The virtual viewpoint image generation unit 303 generates a virtual viewpoint image by using the data read out from the storage device 301 and the virtual camera path output from the virtual camera path generation unit 304, and outputs the generated virtual viewpoint image.

A description of the virtual camera path generation unit 304 and the virtual camera operation unit 305 will be omitted because of being similar to the description of FIG. 2.

The operation authority determination unit 306 analyzes the presence or absence of the operation authority in the content. In a case where the operation authority is present, the operation of the virtual camera is permitted.

The NFT authentication unit 307 authenticates the assignment of the NFT to the content.

### <User Interface (UI) for Virtual Camera Path Editing Processing>

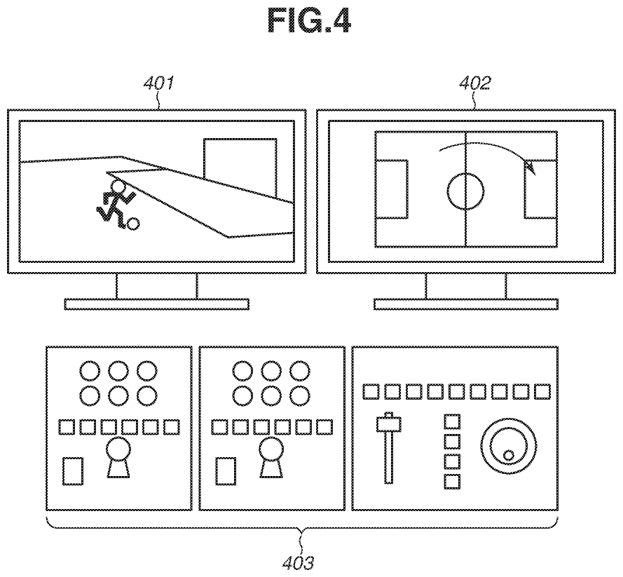

FIG. 4 illustrates examples of a UI for editing the virtual camera path. A virtual camera image display unit 401 displays the image generated by the virtual viewpoint image generation unit 203, namely, the image viewed from the virtual camera. A GUI display unit 402 displays information about the virtual camera path, information about the key frames, and the like. A virtual camera path editing controller 403 is used by the user to edit the virtual camera path.

The virtual camera path editing unit 202 constantly transmits, to the virtual viewpoint image generation unit 203, information about the frame to be edited by the user. The virtual viewpoint image generation unit 203 generates a virtual viewpoint image based on the received information about the frame. The generated virtual viewpoint image is transmitted to and displayed on the virtual camera image display unit 401. As a result, the user can edit the virtual camera path while constantly checking the image of the frame to be edited that is viewed from the virtual camera.

The virtual camera image display unit 401 and the virtual camera path editing controller 403 described above may be implemented, for example, by a touch panel of a tablet terminal or a smartphone.

### <Purchase Rank>

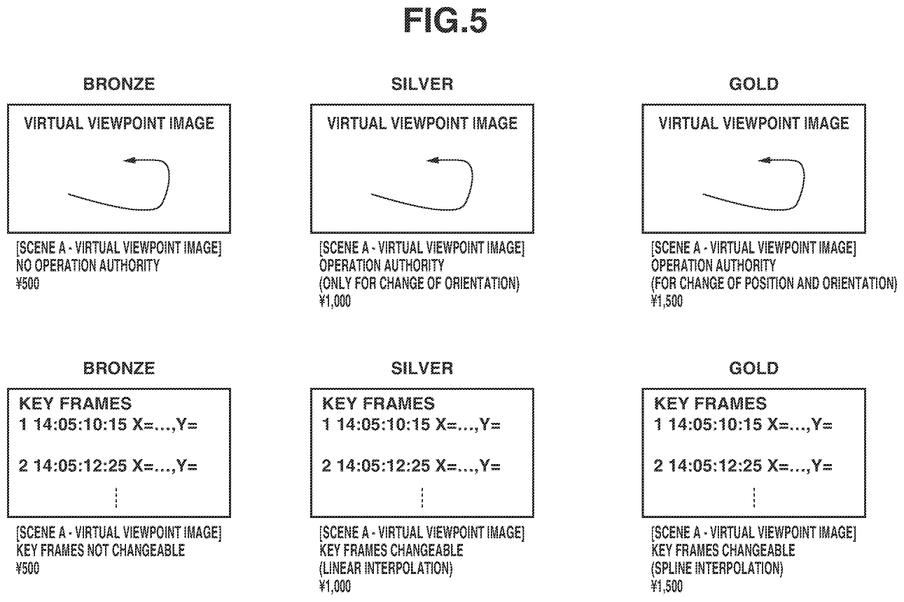

An example of selling the virtual viewpoint image according to the present exemplary embodiment will be described with reference to FIG. 5. FIG. 5 illustrates an example of a sales site for the virtual viewpoint image and illustrates purchase prices of the virtual viewpoint image and the operation authority corresponding each of the purchase prices. The operation authority depends on the purchase price and is defined as a purchase rank. In FIG. 5, three stages of the purchase rank are defined.

The purchase rank of the first stage is defined as “Bronze”. There is no operation authority for the virtual camera, and the purchase price is 500 yen which is the cheapest. The virtual viewpoint image of this purchase rank is limited to the image that can be enjoyed simply based on the virtual camera path generated by the virtual viewpoint image content creator. The purchase rank of the second stage is similarly defined as “Silver”. There is operation authority for the virtual camera, but the operation range of the virtual camera is limited to the change of the orientation, such as pan, tilt, and roll, of the virtual camera. The purchase price is 1000 yen which is more expensive than that of the purchase rank “Bronze”. The purchase rank of the third stage is similarly defined as “Gold”. There is operation authority for the virtual camera, and the position of the virtual camera can be additionally changed. The price is thus 1500 yen which is the most expensive.

The lower part of FIG. 5 illustrates examples in which the key frames are changeable. The key frames can be changed depending on the purchase rank, and a method for interpolation between the key frames depends on the purchase rank.

With the first stage, the key frames are not changeable. With the second stage, the key frames are changeable, and the method for interpolation between the key frames is linear interpolation. With the third stage, the key frames are changeable, and the method for interpolation between the key frames is spline interpolation.

### <Flowchart for Virtual Viewpoint Image Generation>

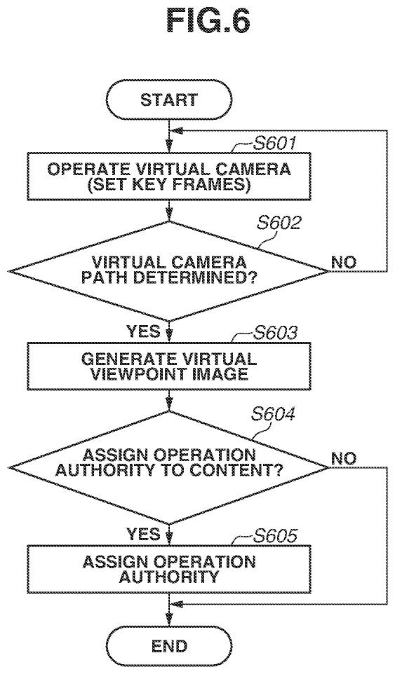

FIG. 6 is a flowchart illustrating a procedure for processing performed by the information processing apparatus 10 according to the present exemplary embodiment. FIG. 6 illustrates a case where a virtual viewpoint image clip is generated based on the captured images.

In step S601, a virtual viewpoint image content creator operates the virtual camera operation unit 205 to generate a virtual viewpoint image clip by setting the key frames or the like.

In step S602, in a case where the virtual camera path is determined through the key frame setting and the manual virtual camera operation by the virtual viewpoint image content creator (YES in step S602), the processing proceeds to step S603. In step S603, the virtual viewpoint image generation unit 203 generates a virtual viewpoint image by using the virtual camera parameters.

In step S604, in a case where the virtual viewpoint image content creator is to assign the operation authority for the virtual camera to the content (YES in step S604), the processing proceeds to step S605. In step S605, the virtual camera operation authority assignment unit 206 assigns the operation authority to permit the operation of the virtual viewpoint image. In a case where the operation authority is not to be assigned (NO in step S604), the processing ends. The operation authority is assigned to three-dimensional (3D) multi-viewpoint images as a basis of the generated virtual viewpoint image. As a result, the purchaser of the virtual viewpoint image can operate the virtual viewpoint image based on the purchase rank. At this time, the NFT assignment unit 207 may perform processing for assigning an NFT to the virtual viewpoint image.

### <Flowchart for Operation by Virtual Viewpoint Image Purchaser>

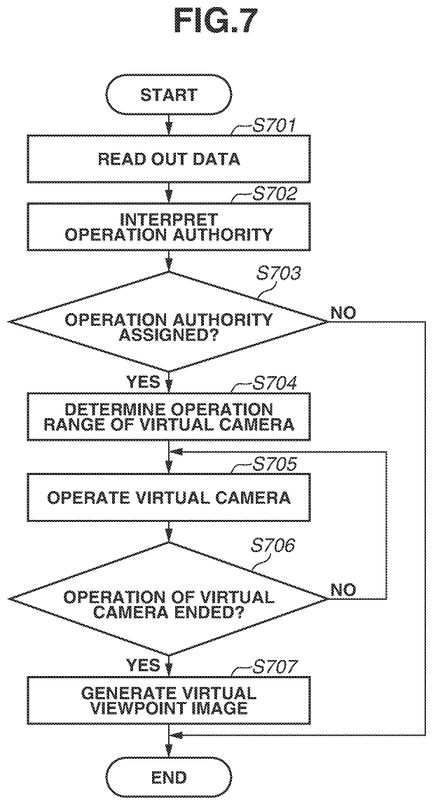

FIG. 7 is a flowchart illustrating a procedure for virtual camera path regeneration processing by the information processing apparatus 10 (illustrated in FIG. 1) according to the present exemplary embodiment. The processing assumes a case where the purchaser of the virtual viewpoint image enjoys the image while editing the virtual camera path for the already generated virtual viewpoint image clip on a terminal such as a smart phone, a tablet, or a personal computer (PC).

In step S701, the virtual viewpoint image generation unit 303 reads out the virtual viewpoint image data from the storage device 301.

In step S702, the operation authority determination unit 306 determines whether the operation authority has been assigned to the data read out in step S701.

In step S703, in a case where the operation authority has not been assigned (NO in step S703), the processing ends. In a case where the operation authority has been assigned (YES in step S703), the processing proceeds to step S704.

In step S704, the virtual camera operation unit 305 sets the operation range of the virtual camera. At this time, in a case where an NFT has been assigned, the NFT authentication unit 307 performs authentication.

The “operation range” will now be described. The operation range indicates an operable range of the virtual camera in which the virtual viewpoint image purchaser is permitted to operate the virtual camera. For example, stages are set for the operation range. The user (the virtual viewpoint image purchaser) with the first stage can freely set only pan, tilt, and roll values for the preset virtual camera path. The virtual viewpoint image purchaser with the second stage can additionally move the position of the virtual camera.

In step S705, the user operates the virtual camera within the operation range and generates a virtual viewpoint image clip (by performing the virtual camera operation and the key frame method described above).

In step S706, in a case where the user ends the editing of the virtual camera path (YES in step S706), the processing proceeds to step S707.

In step S707, the virtual viewpoint image generation unit 303 regenerates the virtual viewpoint image from the virtual camera path information (the position and orientation of the virtual camera) output from the virtual camera path generation unit 304 and the image read out from the storage device 301.

### <Key Frame Operation>

A second exemplary embodiment deals with an example in which the user changes the setting of the key frames of the virtual viewpoint image clip generated using the key frame method, thereby regenerating the virtual viewpoint image clip.

The entire configuration for virtual viewpoint image generation is similar to the configuration according to the first exemplary embodiment. In the present exemplary embodiment, the user can change the setting of the key frames of the virtual camera path preset using the key frame method. Interpolation between the key frames is performed by linear interpolation, spline interpolation, or the like depending on the purchase rank.

### <Configuration>

The configuration for virtual viewpoint image generation is similar to the configuration according to the first exemplary embodiment (see FIGS. 2 and 3). Thus, the description of the configuration will be omitted.

### <Flowchart for Virtual Viewpoint Image Generation>

While a flowchart similar to the flowchart according to the first exemplary embodiment (in FIG. 6) is performed, processing is based on an assumption that the virtual camera image clip is generated using the key frame method. The processing is thus different from that according to the first exemplary embodiment in the following point.

In step S601, the virtual viewpoint image content creator operates the virtual camera operation unit 205 to generate a virtual viewpoint image clip using the key frame method.

### <Flowchart for Operation by Virtual Viewpoint Image Purchaser>

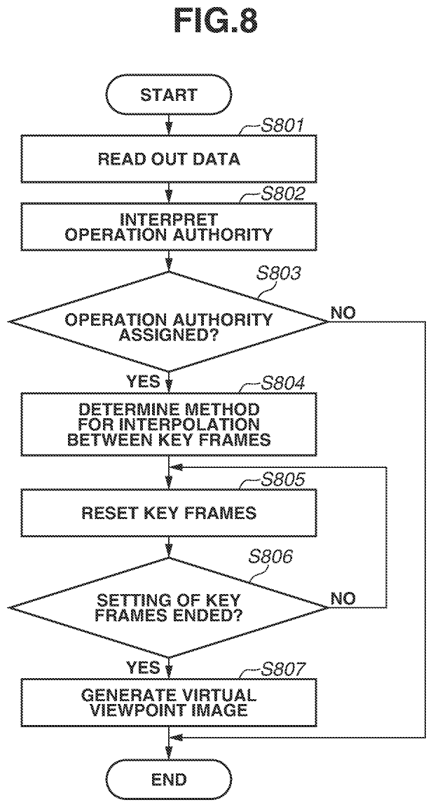

FIG. 8 is a flowchart illustrating a procedure for virtual camera path regeneration processing by the information processing apparatus 10 (illustrated in FIG. 1) according to the present exemplary embodiment.

In step S801, the virtual viewpoint image generation unit 303 reads out the virtual viewpoint image data from the storage device 301.

In step S802, the operation authority determination unit 306 determines whether the operation authority for the data read out in step S801 has been assigned to the user. At this time, in the present exemplary embodiment, the setting of the method for interpolation between the key frames is identified.

In step S803, in a case where the operation authority has not been assigned (NO in step S803), the processing ends. In a case where the operation authority has been assigned (YES in step S803), the processing proceeds to step S804 to output a determination result to the virtual camera operation unit 305.

In step S804, the operation authority determination unit 306 determines whether the virtual viewpoint image purchaser has the operation authority for the content. In addition, the operation authority determination unit 306 determines the method for interpolation between the key frames based on the purchase rank of the virtual viewpoint image purchaser, and outputs information about the determined method to the virtual camera operation unit 305.

In step S805, the virtual viewpoint image purchaser edits (resets) the preset key frames, and the virtual camera operation unit 305 outputs information about the key frames to the virtual camera path generation unit 304.

In step S806, in a case where the virtual viewpoint image purchaser ends the operation of the virtual camera (the editing of the virtual camera path) (YES in step S806), the processing proceeds to step S807.

In step S807, the virtual viewpoint image generation unit 303 regenerates the virtual viewpoint image based on the virtual camera path information (the position and orientation of the virtual camera) output from the virtual camera path generation unit 304 and the image read out from the storage device 301.

### <Assignment of NFT to Key Frame Information>

In a third exemplary embodiment, an NFT is assigned to information about the key frames set in generating the image clip of the virtual viewpoint image.

The present exemplary embodiment is based on an assumption that the virtual viewpoint image content is generated using the key frame method. This corresponds to the virtual viewpoint image generation according to the second exemplary embodiment.

### <Outline of Configuration>

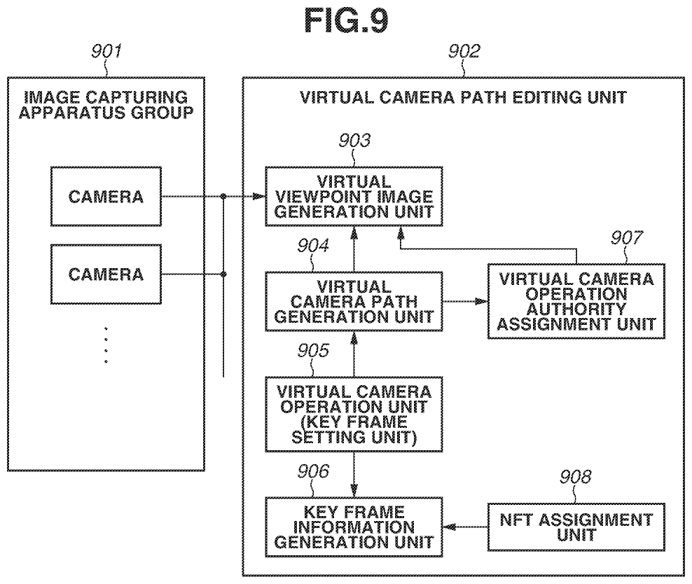

FIG. 9 illustrates an entire configuration according to the present exemplary embodiment. Differences from the first and second exemplary embodiments will be mainly described. An image capturing apparatus group 901 is similar to the image capturing apparatus group 201 illustrated in FIG. 2. A virtual camera path editing unit 902 is used by a virtual viewpoint image content creator to generate a virtual camera path. A virtual camera path generation unit 904 generates a virtual camera path. A virtual camera operation authority assignment unit 907 assigns metadata indicating the operation authority for the virtual camera to a virtual viewpoint image generated by a virtual viewpoint image generation unit 903.

A key frame information generation unit 906 generates key frame information as data to which an NFT is to be assigned based on information about the key frames set by a virtual camera operation unit 905.

An NFT assignment unit 908 assigns an NFT to the key frame information generated by the key frame information generation unit 906.

### <Flowchart>

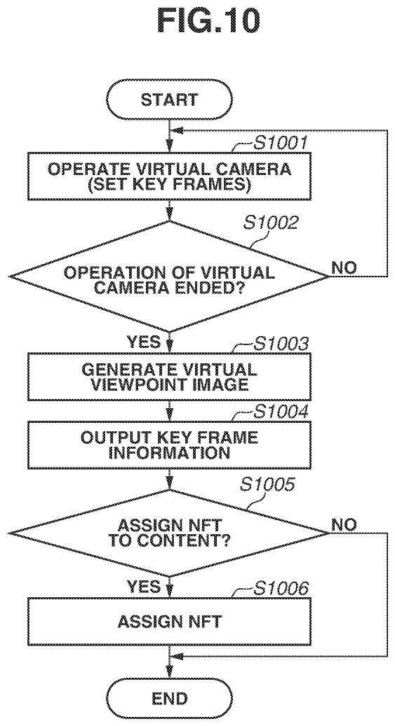

FIG. 10 is a flowchart illustrating a procedure for processing by the information processing apparatus 10 according to the present exemplary embodiment. Differences from the first and second exemplary embodiments will be mainly described.

In step S1001, the virtual viewpoint image content creator operates the virtual camera operation unit 905 to set key frames using the key frame method.

In step S1002, in a case where the virtual viewpoint image content creator ends the operation of the virtual camera and the setting of the key frames (YES in step S1002), the processing proceeds to step S1003. In step S1003, a virtual viewpoint image generation unit 903 generates a virtual viewpoint image using the virtual camera path parameters.

In step S1004, the key frame information generation unit 906 outputs the key frame information (described below) based on the key frames set by the virtual camera operation unit 905.

In step S1005, in a case where an NFT is to be assigned to the key frame information output from the key frame information generation unit 906 (YES in step S1005), the processing proceeds to step S1006. In step S1006, the NFT assignment unit 908 assigns an NFT to the key frame information. In a case where an NFT is not to be assigned (NO in step S1005), the processing ends.

### <Key Frame Information>

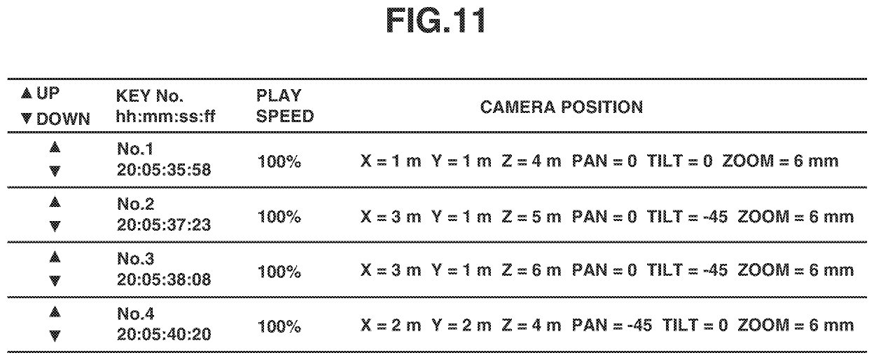

FIG. 11 illustrates an example of the key frame information to which an NFT is to be assigned.

FIG. 11 illustrates a user interface for setting the key frames, which is information output from the key frame information generation unit 906. In FIG. 11, up and down buttons for sorting the key frames, key numbers indicating the order of the key frames and time codes thereof, play speeds between the key frames, and position coordinates and orientation information of the virtual camera are indicated in order from the left as the setting of the key frames. In the present exemplary embodiment, two or more discontinuous frames are set as the key frames, and the frames corresponding to the start time and end time of the virtual viewpoint image are set as the key frames.

A fourth exemplary embodiment assumes a case where a virtual viewpoint image is generated by a terminal not serving as a node of the blockchain.

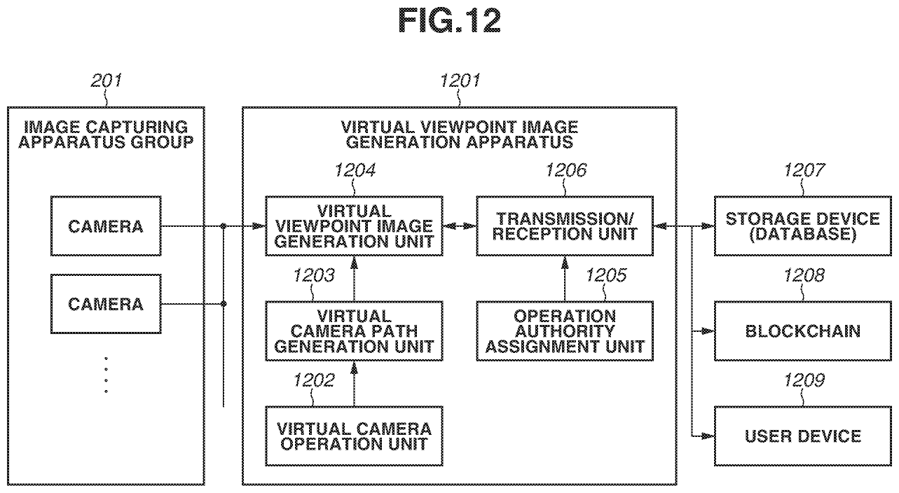

FIG. 12 illustrates a virtual viewpoint image generation system according to the present exemplary embodiment. The virtual viewpoint image generation system according to the present exemplary embodiment includes the image capturing apparatus group 201, a virtual viewpoint image generation apparatus 1201, a storage device 1207, a blockchain 1208, and a user device 1209.

The virtual viewpoint image generation apparatus 1201 includes a virtual camera operation unit 1202, a virtual camera path generation unit 1203, a virtual viewpoint image generation unit 1204, an operation authority assignment unit 1205, and a transmission/reception unit 1206.

The virtual camera operation unit 1202 receives an operation for changing camera parameters of the virtual camera based on an operation by the virtual viewpoint image content creator.

The virtual camera path generation unit 1203 generates a camera path indicating a trajectory of the virtual camera based on input indicating the operation for changing the camera parameters of the virtual camera that is acquired from the virtual camera operation unit 1202. The virtual camera path generation unit 1203 transmits the generated camera path to the virtual viewpoint image generation unit 1204. Alternatively, the camera parameters may be transmitted as appropriate, the camera path from the start to end of generating the virtual viewpoint image may be generated after an instruction to end the generation of the virtual viewpoint image is received from the virtual viewpoint image content creator, and the generated camera path may be transmitted to the virtual viewpoint image generation unit 1204.

The virtual viewpoint image generation unit 1204 generates a three-dimensional model based on the images captured by the image capturing apparatus group 201. The virtual viewpoint image generation unit 1204 then generates a virtual viewpoint image by performing texture mapping with the virtual viewpoint (the position, orientation, and angle of view of the virtual camera) in the virtual camera path generated by the virtual camera path generation unit 1203. The virtual viewpoint image generation unit 1204 also generates a thumbnail image corresponding to the generated virtual viewpoint image. Thereafter, the virtual viewpoint image generation unit 1204 transmits the generated virtual viewpoint image, the three-dimensional model used to generate the virtual viewpoint image, and the thumbnail image corresponding to the virtual viewpoint image to the transmission/reception unit 1206.

The operation authority assignment unit 1205 assigns the operation authority for the virtual camera to the virtual viewpoint image generated by the virtual viewpoint image generation unit 1204. More specifically, the operation authority assignment unit 1205 generates metadata corresponding to the virtual viewpoint image to describe the presence or absence of the operation authority for the virtual camera in the metadata. The operable range of the virtual camera may be limited depending on the rank of the operation authority. Referring to the purchase rank illustrated in FIG. 5 according to the first exemplary embodiment, if the rank is “Silver”, information indicating that the orientation (pan, tilt, and roll) of the virtual camera is operable is generated. If the rank is “Gold”, information indicating that the position and orientation (X axis, Y axis, Z axis, pan, tilt, and roll) of the virtual camera are operable and the X axis, the Y axis, and the Z axis indicate an operable range in a space as a site where the virtual viewpoint image is captured is generated. In a case where the site is a basketball court, the X axis and the Y axis indicate a range surrounded by end lines and side lines as the operable range, and the Z axis indicates a range not going under the ground and the background model as the operable range. Such information is generated as the metadata together with the description of the presence or absence of the operation authority for the virtual camera.

The transmission/reception unit 1206 transmits the virtual viewpoint image generated by the virtual viewpoint image generation unit 1204 and the metadata including the operation authority for the virtual camera generated by the operation authority assignment unit 1205, to an external apparatus.

In the present exemplary embodiment, the virtual viewpoint image and the metadata including the operation authority for the virtual camera are transmitted to the storage device 1207.

The storage device 1207 stores the virtual viewpoint image, material data corresponding to the virtual viewpoint image, and the metadata including the operation authority for the virtual camera. The virtual viewpoint image, the material data corresponding to the virtual viewpoint image, and the metadata including the operation authority for the virtual camera are stored in association with one another. The virtual viewpoint image, the material data corresponding to the virtual viewpoint image, and the metadata including the operation authority for the virtual camera may be managed in different databases as long as these are associated with one another. The material data corresponding to the virtual viewpoint image is at least one of the plurality of captured images used to generate the virtual viewpoint image, the three-dimensional model representing the object, and the three-dimensional model representing the background.

The blockchain 1208 issues an NFT to the virtual viewpoint image and creates and records a transaction. A description of smart contract for issuing the NFT will be omitted here.

The user device 1209 is, for example, a tablet terminal and displays the virtual viewpoint image transmitted via the transmission/reception unit 1206. In a case where the virtual viewpoint image purchaser is a user having the operation authority for the virtual camera, the user device 1209 determines the camera parameters corresponding to the virtual camera based on the user's operation and transmits the camera parameters to the transmission/reception unit 1206.

In the present exemplary embodiment, a case where the virtual viewpoint image to which an NFT is assigned is sold is assumed. Virtual viewpoint images are differentiated depending on the presence or absence of the operation authority for the virtual camera in the metadata corresponding to each virtual viewpoint image, and the operable range. In other words, a plurality of virtual viewpoint images generated by capturing an image of the three-dimensional model of the same object is present, and the presence or absence of the operation authority for the virtual camera and the operable range are described in the metadata of each of the plurality of virtual viewpoint images. The virtual viewpoint image generation apparatus 1201 can determine whether the virtual viewpoint image purchaser having purchased a virtual viewpoint image can operate the virtual camera, by making an inquiry using the NFT. The virtual viewpoint image purchaser who can operate the virtual camera can generate a new virtual viewpoint image by using the material data corresponding to the virtual viewpoint image to which the NFT is assigned. The virtual viewpoint image that can be generated at this time is a virtual viewpoint image obtained when the material data corresponding to the virtual viewpoint image to which the NFT is assigned is viewed from a desired position and orientation of the virtual camera operated by the virtual viewpoint image purchaser.

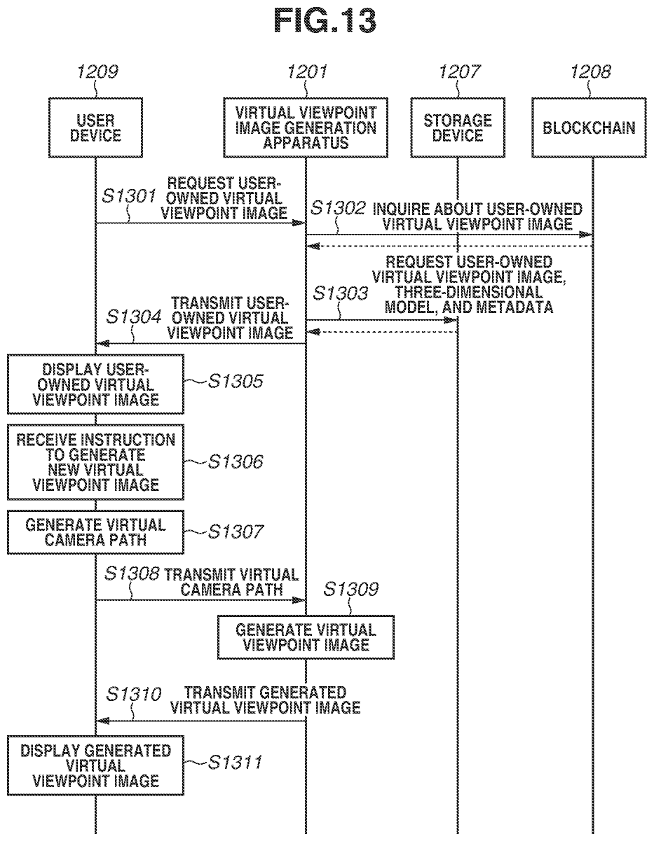

FIG. 13 illustrates a procedure for processing performed in a case where the virtual viewpoint image purchaser generates a new virtual viewpoint image.

In step S1301, the user device 1209 transmits a request for the virtual viewpoint image owned by the virtual viewpoint image purchaser (the user) to the virtual viewpoint image generation apparatus 1201.

In step S1302, the virtual viewpoint image generation apparatus 1201 inquires of the blockchain 1208 about the virtual viewpoint image owned by the virtual viewpoint image purchaser. It is assumed here that the inquiry about the virtual viewpoint image owned by the virtual viewpoint image purchaser is made by transmitting a user identification (ID) corresponding to the virtual viewpoint image purchaser and checking the transaction described in the blockchain 1208. It is also assumed that the user ID corresponds to the virtual viewpoint image purchaser and is managed by the virtual viewpoint image generation apparatus 1201 using an existing account management method (not illustrated). The blockchain 1208 identifies the virtual viewpoint image owned by the virtual viewpoint image purchaser and transmits information about the identified virtual viewpoint image to the virtual viewpoint image generation apparatus 1201.

In step S1303, the virtual viewpoint image generation apparatus 1201 transmits a request for the virtual viewpoint image owned by the virtual viewpoint image purchaser, the material data corresponding to the virtual viewpoint image, and the metadata to the storage device 1207. At this time, the virtual viewpoint image owned by the virtual viewpoint image purchaser is assumed to be associated with the user ID. For example, the virtual viewpoint image generation apparatus 1201 stores an ID indicating the virtual viewpoint image and the user ID in association with each other. Alternatively, a storage device may be separately provided. The storage device 1207 transmits, to the virtual viewpoint image generation apparatus 1201, a thumbnail image of the virtual viewpoint image owned by the virtual viewpoint image purchaser and the metadata corresponding to the operation authority for the virtual camera owned by the virtual viewpoint image purchaser.

In step S1304, the virtual viewpoint image generation apparatus 1201 transmits the virtual viewpoint image owned by the virtual viewpoint image purchaser to the user device 1209. In a case where the operable range of the virtual camera is set in the metadata, the virtual viewpoint image generation apparatus 1201 transmits the acquired metadata to the user device 1209.

In step S1305, the user device 1209 displays the virtual viewpoint image acquired in step S1304.

In step S1306, the user device 1209 receives an instruction to generate a new virtual viewpoint image through input by the virtual viewpoint image purchaser. After receiving the instruction, the user device 1209 displays a UI for generating the new virtual viewpoint image (not illustrated).

In step S1307, the user device 1209 receives the operation of the virtual camera by the virtual viewpoint image purchaser. The user device 1209 may display the virtual viewpoint image generated by the virtual viewpoint image content creator until receiving the operation of the virtual camera. In a case where the user device 1209 is a tablet terminal, the user device 1209 displays a bird's-eye view showing the virtual space and generates the virtual camera path through a slide operation with a touch pen. In a case where the operable range of the virtual camera is set, the virtual camera path is generated within the operable range of the virtual camera.

In step S1308, the user device 1209 transmits the generated virtual camera path to the virtual viewpoint image generation apparatus 1201.

In step S1309, the virtual viewpoint image generation apparatus 1201 generates a virtual viewpoint image based on the virtual camera path acquired in step S1308 and the three-dimensional model acquired in step S1303.

In step S1310, the virtual viewpoint image generation apparatus 1201 transmits the virtual viewpoint image generated in step S1309 to the user device 1209.

In step S1311, the user device 1209 displays the virtual viewpoint image generated in step S1309.

Through the above-described processing, the virtual viewpoint image purchaser can generate a new virtual viewpoint image by using the three-dimensional model used to generate the purchased virtual viewpoint image.

In the present exemplary embodiment, the virtual camera path is generated in step S1307, and the generated virtual camera path is transmitted to the virtual viewpoint image generation apparatus 1201. However, the present exemplary embodiment is not limited thereto. For example, the position and orientation of the virtual camera corresponding to each frame may be operated, and the virtual viewpoint image may be generated and displayed as appropriate. In this case, steps S1307 to S1311 are repeated for each frame. An example of the operation of the position and orientation of the virtual camera is that, when a slide operation, a pinch-in operation, or a pinch-out operation is received, it is determined that the operation of the virtual camera has been received. In the case where the operation of the virtual camera has been received, change amounts from the position and orientation of the virtual camera corresponding to the displayed virtual viewpoint image are calculated based on an operation amount of the slide operation. The calculated change amounts are reflected in the camera parameters of the virtual camera to update the camera parameters of the virtual camera. The camera parameters of the virtual camera to be updated are restricted based on the metadata. For example, in a case where the metadata is information indicating that the pan, tilt, and roll of the virtual camera are operable, the camera parameters are restricted so that the camera parameters for pan, tilt, and roll are updated but the camera parameters for the X-, Y-, and Z-axes are not updated.

While the exemplary embodiments of the present disclosure are described in detail above, the present disclosure is not limited to the above-described exemplary embodiments, various modifications can be made based on the spirit of the present disclosure, and the various modifications are not excluded from the scope of the present disclosure. For example, the above-described first to fourth exemplary embodiments may be appropriately combined. According to the exemplary embodiments of the present disclosure, a user who has purchased a virtual viewpoint image can generate a new virtual viewpoint image of the same scene that is viewed from a desired viewpoint.

A computer program for implementing a part or all of the control according to the above-described exemplary embodiments or the functions according to the exemplary embodiments may be supplied to an image processing system via a network or any of various storage media. Then, a computer (e.g., CPU or a microprocessor unit (MPU)) of the image processing system may read out and execute the program. In this case, the program and the storage medium storing the program are included in the exemplary embodiments of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-190838, filed Nov. 29, 2022, which is hereby incorporated by reference herein in its entirety.

What is claimed is:

1. An image processing apparatus comprising:
one or more memories storing instructions; and
one or more processors executing the instructions to:
generate a virtual viewpoint image based on a plurality of images captured by a plurality of image capturing apparatuses and based on information indicating a position and an orientation of a virtual camera;
generate, based on input of a generation instruction, permission information indicating that an operation of the virtual camera corresponding to the virtual viewpoint image is permitted; and
output the virtual viewpoint image and the permission information in association with each other.

2. The image processing apparatus according to claim 1, wherein the generation instruction is input based on a user operation.

3. The image processing apparatus according to claim 1, wherein the permission information is information indicating that a user is permitted to operate at least one of the position and the orientation of the virtual camera.

4. The image processing apparatus according to claim 3, wherein the permission information includes information indicating a range in which at least one of the position and the orientation of the virtual camera is operable by the user.

5. The image processing apparatus according to claim 4, wherein the information indicating the range in which at least one of the position and the orientation of the virtual camera is operable is determined based on a price set for the virtual viewpoint image.

6. The image processing apparatus according to claim 1, wherein the information indicating the position and the orientation of the virtual camera is information indicating an X-axis value, a Y-axis value, a Z-axis value, a pan value, a tilt value, and a roll value of the virtual camera.

7. The image processing apparatus according to claim 1, wherein the information indicating the position and the orientation of the virtual camera is information specified based on a user operation.

8. The image processing apparatus according to claim 7, wherein the information indicating the position and the orientation of the virtual camera is information indicating positions and orientations of the virtual camera corresponding to two or more discontinuous frames and is associated with a non-fungible token.

9. The image processing apparatus according to claim 1, wherein the information indicating the position and the orientation of the virtual camera is information indicating positions and orientations of the virtual camera corresponding to two or more frames.

10. The image processing apparatus according to claim 1, wherein the virtual viewpoint image is associated with a non-fungible token.

11. An image processing apparatus comprising:
one or more memories storing instructions; and
one or more processors executing the instructions to:
acquire, in a case where permission information indicating that an operation of a virtual camera is permitted is acquired, information indicating a position and an orientation of the virtual camera; and
generate a virtual viewpoint image based on material data used to generate a virtual viewpoint image corresponding to the permission information and based on the information indicating the position and the orientation of the virtual camera.

12. The image processing apparatus according to claim 11, wherein the material data is a plurality of images captured by a plurality of image capturing apparatuses, or a three-dimensional shape model.

13. The image processing apparatus according to claim 11, wherein the one or more processors further execute the instructions to generate a virtual viewpoint image that is different from the virtual viewpoint image corresponding to the permission information.

14. The image processing apparatus according to claim 11, wherein the one or more processors further execute the instructions to output, to another apparatus, the generated virtual viewpoint image.

15. The image processing apparatus according to claim 11, wherein the information indicating the position and the orientation of the virtual camera is acquired by a user operation.

16. An image processing method comprising:
generating a virtual viewpoint image based on a plurality of images captured by a plurality of image capturing apparatuses and based on information indicating a position and an orientation of a virtual camera;
generating, based on input of a generation instruction, permission information indicating that an operation of the virtual camera corresponding to the virtual viewpoint image is permitted; and
outputting the virtual viewpoint image and the permission information in association with each other.

17. A non-transitory computer-readable storage medium storing a computer program for causing a computer to execute an image processing method comprising:
generating a virtual viewpoint image based on a plurality of images captured by a plurality of image capturing apparatuses and based on information indicating a position and an orientation of a virtual camera;
generating, based on input of a generation instruction, permission information indicating that an operation of the virtual camera corresponding to the virtual viewpoint image is permitted; and
outputting the virtual viewpoint image and the permission information in association with each other.
